(19) United States
(12) Patent Application Publication
(10) Pub. No.: US 2011/0009105 A1
(43) Pub. Date: Jan. 13, 2011

(54) SELF-ORGANIZING NETWORKS USING DIRECTIONAL BEAM ANTENNAS

(76) Inventors: JUNGWOO LEE, SOUTH PLAINFIELD, NJ (US); SEYONG PARK, SUMMIT, NJ (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 12/553,258

(22) Filed: Sep. 3, 2009

Related U.S. Application Data
(60) Provisional application No. 61/224,977, filed on Jul. 13, 2009.

(51) Int. Cl. H04M 3/00; H04W 72/00

(52) U.S. Cl. 455/418; 455/452.1

(57) ABSTRACT

A method for determining whether to reconfigure a self-organizing network (SON) comprising coverage areas each having a BTS and an antenna and mobile units operating in each coverage area. The method comprises: at each BTS, scanning an antenna beam, measuring performance data, and determining whether measured performance data indicates a network reconfiguration; if a result is negative, at a first BTS returning to the step of scanning the antenna beam; if the result is affirmative, selecting one or more of reconfiguring the SON by changing the RF output power of the first BTS, changing an antenna beam pattern of the antenna at the first BTS, changing an antenna tilt angle of the antenna at the first BTS, changing an operating frequency of the first BTS and updating a proximate cell site list of the first BTS.

### CROSS-REFERENCE TO RELATED APPLICATIONS

The present application claims priority to a provisional application entitled Self-Organizing Networks within Picocell and Femtocell Network Coverage Areas Using Directional Beam Antennas, filed on Jul. 13, 2009 and assigned application No. 61/224,977. The contents of the provisional application are hereby incorporated by reference.

### FIELD OF THE INVENTION

The present invention relates to wireless communications networks, femtocells, smart antennas, and interference mitigation.

### BACKGROUND OF THE INVENTION

A femtocell/picocell network comprises a relatively small radio coverage area (wireless) with a base station for receiving signals from and sending signals to mobile units within the femtocell coverage area. The femtocell/picocell networks are typically deployed as either a residential or an enterprise in-building wireless network. The base station is generally a fully-featured but low-power mobile phone base station and is connected into a mobile operator's network using standard broadband (IP-based) DSL or cable services. From the mobile operator's network the calling party can connect to any called party. Call handoffs from a femtocell/picocell base station to a macrocell base station (and also vice versa) are also executed through the IP-based network.

The femtocell (including picocell) equipment offers excellent mobile phone coverage in the residential or in-building wireless network for both voice and data, and at lower cost than traditional outdoor cellular services that operate in macrocell networks. Picocell networks employ equipment that is similar to femtocell networks, but generally operate at a higher base station output power and thus have a larger radio coverage area.

The macrocell or cellular network comprises a radio coverage area in which a cellular base station provides RF connectivity to mobile phones in the coverage area. The macrocell antennas are mounted on ground-based masts, rooftops and other existing structures, at a height that provides a clear view over the surrounding buildings and terrain. Macrocell base stations have power outputs of typically tens of watts and operate in licensed portions of the RF spectrum.

Unlike WiFi modems and routers but like cellular base stations, a femtocell/picocell base station uses a frequency within a licensed radio spectrum and thus must be operated and controlled by the mobile phone company. The femtocell/picocell base station therefore interoperates only with the services and networks of the mobile phone company operating the femtocell/picocell base station. Other services outside the operator's network are reached through conventional interconnecting networks.

When in range of the femtocell/picocell base station at home or within the office, a user's mobile phone automatically detects the femtocell/picocell base station and uses it in preference to outdoor cellular base stations. Calls are made and received as when operating with an outdoor cellular base station (i.e., a macrocell), except the signals are sent/received in an encrypted format from the femtocell/picocell base station to one of the mobile operators main switching centers via a broadband IP network.

Making and receiving calls in the femtocell/picocell network uses the same procedures and telephone numbers as when operating within the cellular macrocell network. All standard phone and mobile unit features (e.g., call divert, text messaging, web browsing) are also available. It is expected that data services will operate more robustly and efficiently due to the short range of the femtocell/picocell system.

The femtocell/picocell base station can receive relatively low power radio signals, i.e., lower power than cordless phones and WiFi modems and routers. This feature substantially increases battery life of the mobile units, both in standby and talk-time modes. Femtocell/picocell base stations can handle up to three or four simultaneous calls from different mobile units. The femtocell/picocell base station employs any of several different algorithms to sense an available radio frequency and to determine a power level for transmitting to mobile units within the coverage area.

Femtocells/picocells are viable indoor solutions for wireless mobile units in areas where macrocell coverage is problematic, i.e., the wireless devices cannot connect to the base station due to, for example, signal shadowing and distance. A femtocell/picocell network can boost the capacity for most existing wireless standards, e.g., CDMA, WCDMA, WiMAX, and LTE. Typically, a femtocell/picocells base station operates according to the WiMAX or LTE protocols.

Frequency reuse within a femtocell/picocell coverage area is common in femtocell/picocell networks that use time division duplexing (TDD), where for any one base station the same frequency is used for uplink signals (i.e., from a mobile unit to a base station, also referred to as reverse link signals), and downlink signals (i.e., from a base station to a mobile unit, also referred to as forward link signals). Interference (i.e., intra-cell interference) is avoided by assigning time slots to the uplink and downlink signals. The number of time slots available for the uplink and downlink signals are dynamically assigned based on the data traffic in each direction and are therefore typically asymmetric.

Interference may also be present between proximate femtocell/picocell coverage areas (inter-cell interference) due to frequency reuse. For example, for a frequency reuse factor of one, adjacent coverage areas use the same frequencies regardless of the communication protocol employed.

Generally, in a femtocell/picocell network there are four different types of inter-cell interference to be considered:

(1) interference to uplink communication signals in a femtocell/picocell coverage area of interest, where the interference is caused by signals transmitted from a proximate femtocell/picocell base station;

(2) interference to uplink communication signals in a femtocell/picocell coverage area of interest, where the interference is caused by signals transmitted from mobile units operating in a proximate femtocell/picocell coverage area;

(3) interference to downlink communication signals in a femtocell/picocell coverage area of interest, where the interference is caused by signals transmitted from a proximate femtocell/picocell base station; and

(4) interference to downlink communication signals in a femtocell/picocell coverage area of interest, where the interference is caused by signals transmitted from mobile units operating in a proximate femtocell/picocell coverage area.

Item (1) of the four listed is the most problematic due to the relatively high power of the interfering signals transmitted from a base station (i.e., the downlink signals) and the relatively low power signals transmitted from a mobile unit (i.e., the uplink signals) in the femtocell/picocell coverage area of interest. The interference is especially problematic if the uplink signal and the proximate base station signal share the same frequency. In particular, a pilot signal transmitted from the femtocell/picocell base station to all mobile units within its coverage area can cause interference in neighboring femtocells/picocells. Each pilot signal transmitted from a femtocell/picocell base station includes a coverage area identifier embedded in the pilot signal. The coverage area identifier can be used to identify pilot signals from femtocells/picocells base stations operating in other coverage areas.

Signals carried in proximate or overlying macrocell coverage areas are also a problem with today's femtocell/picocell technologies. Interference is aggravated by deployment of the femtocell/picocell equipment by users without any cell site planning or RF engineering. Conventional approaches to address the interference problem in orthogonal frequency division multiple access femtocell/picocell systems include power control and sub-channel allocation. But these approaches have drawbacks, including reduced data throughput and user capacity.

A solution to the interference problem is desired to encourage successful deployment and reliable operation of picocell/femtocell equipment.

In addition to interference issues, once the picocell/femtocell equipment is deployed, the equipment must be maintained to manage the picocell/femtocell network. Since installation may not be carefully controlled by the carrier or operator, unlike a macrocell network, it is critical that an operator have the capability of RF engineering the network from a remote site. Use of self-organizing networks (SON) concepts have been discussed in the literature for managing the picocell/femtocell network. The use of an SON, in contrast to pre-setup RF engineering, raises network setup and management challenges. SON concepts may also be applicable to a macrocell network.

### BRIEF DESCRIPTION OF THE DRAWINGS

A more particular description of the invention will be rendered by reference to specific embodiments thereof that are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram depicting a femtocell/picocell system to which the teachings of the present invention can be applied.

FIG. 2 depicts a parasitic antenna array for use with the femtocell/picocell system of FIG. 1.

FIG. 3 is a block diagram of a femtocell/picocell base station including elements for generating control signals supplied to the parasitic array of FIG. 2.

FIG. 4 depicts a flow chart of a method for controlling the parasitic array antenna of FIG. 2.

FIG. 5 is a block diagram of a femtocell/picocell base station including elements for generating signal weights for a beamforming antenna.

FIG. 6 depicts a flow chart of a method for controlling the beamforming antenna of FIG. 5.

FIG. 7 is a network diagram illustrating multiple picocells/femtocells coverage areas.

FIG. 8 is a flowchart illustrating the a distributed control mode of a self-organizing network.

FIG. 9 is a flowchart illustrating a centralized control mode of the self-organizing network.

FIG. 10 is a block diagram of a stand-alone switched parasitic array antenna system.

FIG. 11 is a block diagram of a network employing the stand-alone switched parasitic arrays of FIG. 10.

Wherever possible, the same reference numerals used throughout the drawings refer to the same or like parts.

### DETAILED DESCRIPTION OF THE INVENTION

Before describing in detail the various embodiments of an apparatus and method for reducing interference between signals carried within proximate femtocells, it should be observed that the present invention resides primarily in a novel and non-obvious combination of elements and process steps. So as not to obscure the disclosure with details that will be readily apparent to those skilled in the art, certain conventional elements and steps have been presented with lesser detail, while the drawings and the specification describe in greater detail other elements and steps pertinent to understanding the invention.

The following embodiments are not intended to define limits of the structure or method of the invention but only to provide exemplary constructions. The embodiments are permissive rather than mandatory and illustrative rather than exhaustive.

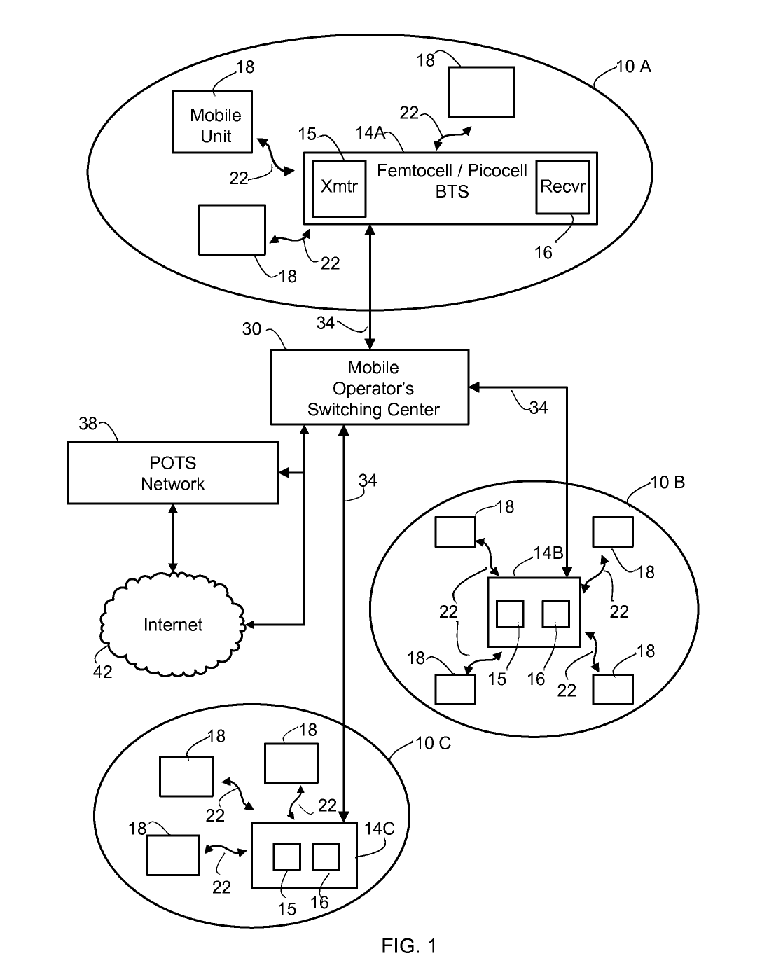

FIG. 1 illustrates several femtocell/picocell coverage areas 10A, 10B and 10C and a femtocell/picocell base transceiver station (BTS) 14A, 14B, and 14C within the corresponding coverage area 10A, 10B and 10C. Each BTS 14A, 14B, and 14C includes a transmitter 15 and a receiver 16. Mobile units 18 within the coverage area 10A communicate with the corresponding femtocell/picocell BTS 14A over an RF link 22. Each mobile unit includes both a transmitter and a receiver not separately illustrated. Each femtocell/picocell BTS 14A, 14B and 14C connects to a mobile operator's switching center 30 via an IP-based or dedicated link 34. The switching center 30 in turn connects to a POTS (plain old telephone system) network 38 or to other sites on an Internet 42 as may be required.

Certain exemplary embodiments of the present invention solve signal interference problems in a femtocell/picocell coverage area by providing a system and method for limiting interference between signals carried (i.e., transmitted and received) between mobile units and a base station transceiver within a first femtocell/picocell coverage area and signals carried within a second proximate femtocell/picocell coverage area. This type of interference is known as inter-cell interference. The system and method may also limit interference between the femtocell/picocell signals and signals carried within a proximate or overlying macrocell coverage area.

According to one embodiment of the invention, a directional beam antenna is employed at the femtocell/picocell base station to mitigate inter-cell interference, in particular, interference caused by downlink signals transmitted from proximate BTSs. Uplink signals sent to proximate BTSs from mobile units operating in a proximate coverage area can also be problematic. The directional beam antenna reduces signal interference with little, if any, reduction in data throughput or user capacity. Generally, it is considered prudent to use the same beam pattern for uplink and downlink signals. There are two possible approaches to creating a directional antenna beam (for use in both sending and receiving signals) from the base station antenna.

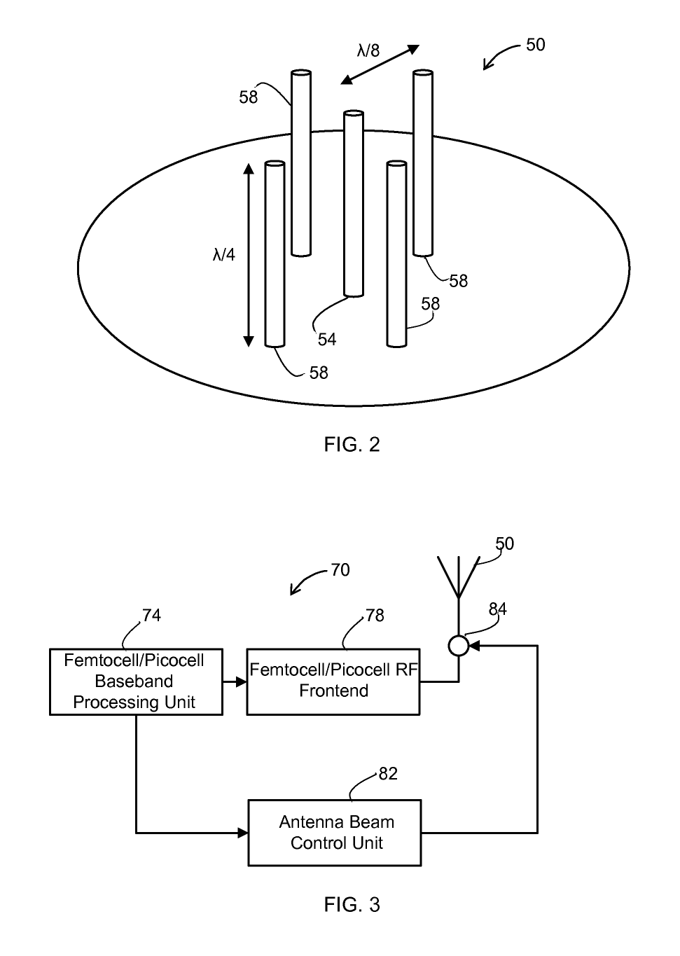

A first approach utilizes a switched parasitic array (SPA) 50 (see FIG. 2) comprising an active antenna element 54 surrounded by a plurality of parasitic elements 58. An SPA antenna beam pattern is controllable by proper control of the parasitic elements 58. This technique is useful for interference mitigation because the antenna beam pattern/direction can be changed without using multiple antennas and corresponding multiple RF chains in the base station equipment. Thus it may be a cost-effective solution to the femtocell/picocell inter-cell interference problem.

The active antenna element 54 (shown as located at approximately a center of the parasitic array) is connected to the transmitter 15 and receiver 16 of each BTS 14A/14B/14C. Four (or more) passive or parasitic antenna elements 58 can be switched on and off according to a state of a corresponding PIN diode (not shown). By appropriately switching the passive elements, i.e., shorting the elements to ground via a conducting PIN diode or opening the connection to ground by controlling the PIN diode to a non-conducting state, various antenna beam patterns can be obtained.

For optimum performance, in one embodiment the parasitic elements 58 are spaced at about λ/8 from the active element 54 and are about λ/4 in height. A diameter of the parasitic elements 58 is not critical to performance; in one exemplary embodiment the diameter is about λ/200.

FIG. 3 illustrates certain elements of a signal path of a femtocell/picocell base transceiver station (BTS) 70 according to the teachings of the present invention, including a baseband processing unit 74, an RF front end 78 (including both transmitting and receiving components) and an antenna beam control unit 82 connected as illustrated. The beam control unit 82 supplies control signals to beam control switches 84 for controlling a condition of the parasitic elements 58 (four parasitic elements in one embodiment) of FIG. 2. The number of possible beam patterns depends on the number of parasitic elements and for a given number of parasitic elements the number of possible beam patterns is finite and fixed. Increasing the number of parasitic elements creates more beam patterns and decreases a width of each beam pattern.

Any one of various control algorithms can be utilized to determine an optimum beam pattern for receiving signals from each mobile unit communicating with the femtocell/picocell BTS. In one embodiment, one beam pattern is selected for use with all mobile units operating in the coverage area. This beam pattern may be employed both when the BTS is transmitting and receiving. According to one embodiment, this beam pattern is selected to optimally reduce the interference experienced by each of the uplink signals due to downlink signals in proximate coverage areas. According to another embodiment, a unique antenna control signal is designated for each mobile unit in the coverage area. Of course, as a mobile unit moves it may be necessary to determine a different beam pattern for the mobile unit. This can be accomplished by conducting the beam pattern tests at frequent intervals as determined by the mobility of the mobile units in the coverage area and accordingly updating the selected beam pattern as described below. The state of the parasitic elements 58 are accordingly controlled to create a beam pattern that reduces inter-cell interference.

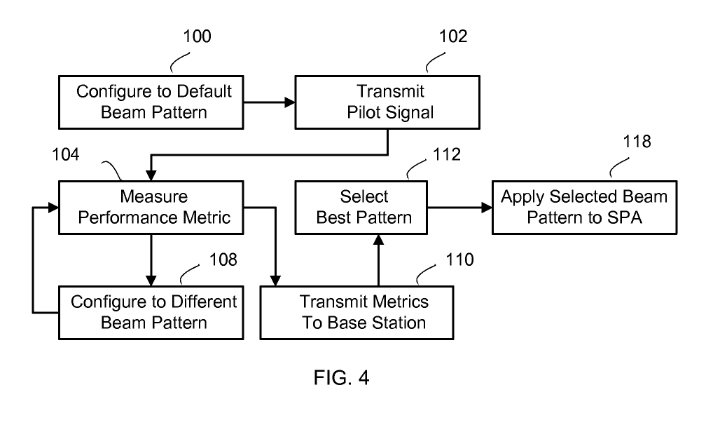

According to an algorithm illustrated in FIG. 4, at an initial step 100 the SPA 50 at the BTS is configured to a default beam pattern (e.g., an omni-directional beam pattern). At a step 102, the BTS 70 transmits a pilot signal, which typically includes an identifier of the femtocell coverage area in which the BTS 70 operates.

At a step 104 each of one or more mobile units measures one or more performance metrics (such as for example, SINR (signal to interference plus noise ratio), PER (packet error rate), BER, throughput (“goodput”) or channel state information (CSI) or SNR), for the pilot signal. The preferable metric reflects a measure of the “goodness” of the system performance. Any of these measured parameters provide a good indication of interference, in a relative sense. Minimizing the BER, for example, by choosing a best beam pattern, minimizes interference within the femtocell/picocell coverage area.

At a step 108 the SPA 50 is configured to a different beam pattern and each mobile unit again measures the signal metric at the step 104.

After the pilot tone has been transmitted using all available beam patterns and at least one metric determined for each beam pattern at each mobile unit 18, the measured metrics are transmitted from each mobile unit 18 to the base station 14 at a step 110. Alternatively, the measured metrics can be transmitted back to the base station after each metric is determined and before the SPA 50 is configured to the next beam pattern.

In yet another embodiment, the BTS 70 can measure one or more performance metrics of an uplink signal transmitted from each mobile unit for the default beam pattern and all other configurable beam patterns. For this embodiment to perform satisfactorily it may be necessary to transmit a known signal (such as the pilot tone) from each mobile unit to the BTS.

At a step 112 the baseband processing unit 74 (see FIG. 3) or a signal metric measuring device at the BTS 70 analyzes the signal metrics measured by and transmitted from the mobile units and selects the pattern with the best metric(s). In one embodiment the selected beam pattern maximizes an overall combination of the performance metrics for all mobile units in another embodiment a unique beam pattern is selected for each mobile unit.

The SPA control signal associated with the selected beam pattern is generated within the antenna beam control unit 82 and applied to the SPA 50 (at a step 118) to create the desired beam pattern. The control signal may open or short one or more parasitic elements 58 to form a beam pattern that limits the inter-cell interference. The beam pattern remains unchanged for all signals sent from and received by the femtocell/picocell base station until the base station beam pattern is updated as described below.

In other embodiments the performance metric can be measured at only the base station (using a pilot signal transmitted from the mobile units) or at both the base station and the mobile units. The measured metrics may also be combined to yield a composite performance metric that represents a combination of the base station reception and the mobile unit reception.

Both “dumb” and “smart” approaches can be used to generate new beam patterns from which the optimum pattern is eventually selected.

According to the “dumb” approach, a plurality of predefined beam patterns are generated, using appropriate control signals for the parasitic elements, in a predefined order (e.g., a round robin approach). The dwell time at each beam pattern can be selected by the user/operator. Thus the process loops through the steps 108 and 104 of FIG. 4 until all of beam patterns have been generated and a signal metric determined for each pattern.

According to the “smart” approach, a beam pattern is calculated based on a measured performance metrics as determined at the mobile units and/or at the BTS. The available SPA pattern closest to the calculated beam pattern is selected and under control of the antenna beam control unit 82, the SPA 50 is configured to that beam pattern.

In another embodiment including multiple SPAs 50, an angle or direction of arrival of an interfering signal is determined by the collective analysis of the multiple SPA's. A control signal is then calculated to locate the interfering signal at a null of the antenna beam pattern of one or more of the SPA's 50. If the direction of arrival for the interference signal can be determined, this approach can be an effective method to mitigate interference within the femtocell/picocell coverage area.

Whether a “smart” or “dumb” approach is utilized, signal conditions tend to change with time and thus new beam patterns may be required over time to reduce the inter-cell interference. For example, transient signal conditions or signal traffic patterns can arise that change the interference situation or a new femtocell coverage area can be installed in a neighboring apartment or business suite. Thus the femtocell/picocell beam pattern is modified, using either the “dumb” or “smart” approach described above, according to a user-selectable beam update interval. For example, to overcome transient interference, the beam pattern update interval may relate to a length of a data frame (a logical sub-unit of a data transmission). Each data frame is typically about 5-10 ms in duration.

Alternatively, the beam update time may relate to expected changing signal channel conditions. The applicable wireless standard (e.g., WiMAX, LTE, WCDMA) may also provide guidance on the desired update time. It is also possible to theoretically determine an optimal update period, which is related to the coherence time of a time-dependent fading channel. This coherence time corresponds approximately to an inverse of the signal's Doppler spread.

A second approach to reducing interference in the femtocell/picocell environment uses a beamforming technique based on multiple-input-multiple-output (MIMO) antennas. Although the MIMO technique may employ multiple antennas to form the beam, only one data stream is transmitted/received at any given time.

The SPA approach can be used with a single antenna (single-input-single-output, SISO) and with multiple antennas. The MIMO approach can be used only with MIMO antennas, and may be more costly than the SPA approach due to the multiple antennas and multiple RF processing chains (if the beamforming is performed at baseband). But the MIMO concept may have an advantage over the SPA approach in that it requires minimal changes in the existing (conventional) femtocell/picocell base station architecture. Also, the MIMO concept permits a nearly infinite number of beam patterns and directions, while the SPA approach can configure the beam pattern into only a discrete number of patterns and directions. Further, a spatial multiplexing mode in a MIMO configuration can support multiple data streams and thus a higher data throughput at a high SNR.

Femtocell/picocell base stations currently employ beamforming technology to increase the received signal power, whereas the present invention focuses on reducing interference power input to the receiving antenna. SINR is defined as signal power divided by (noise +interference) power. In the prior art MIMO applications, the signal power is boosted. According to the present invention the signal power remains fixed while the received interference power is reduced. Also, the prior art employs beamforming techniques in a single-cell (coverage area), whereas the present invention applies to multi-cell scenarios.

The MIMO beamforming technique directs a main lobe of the beam pattern to an intended user to improve the quality of the signal communicated between the femtocell base station and the user. In this case the data throughput is not increased because a single data stream is utilized, but the MIMO approach can boost the received SNR.

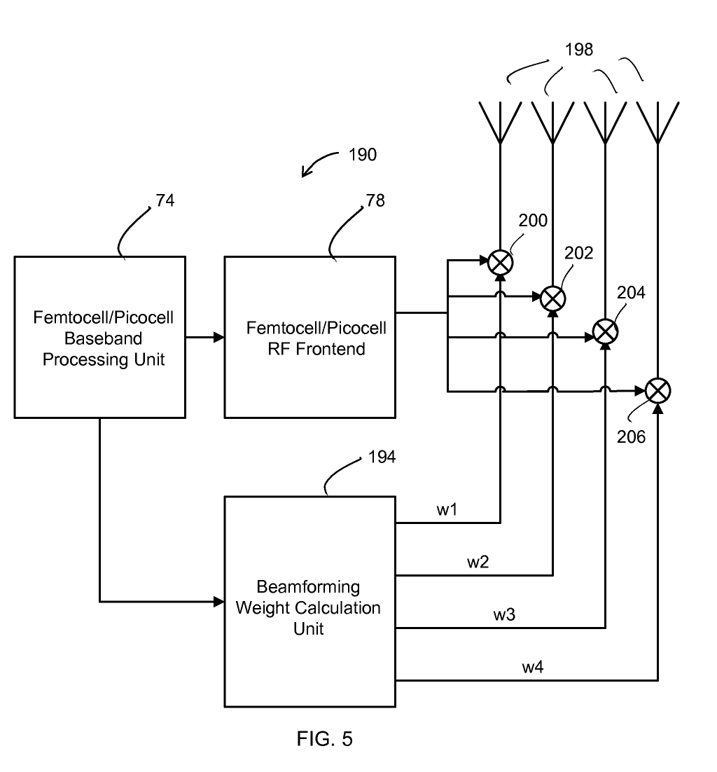

A femtocell base station 190 employing the MIMO approach is shown in FIG. 5. The base station 190 further comprises a beamforming weight calculation unit 194 generating a plurality of weights w1, w2, w3 and w4. Each weight is separately applied to the received or transmitted signal (to/from the RF front end 78) in a corresponding combiner 200, 202, 204 and 206. The weighted signal is then input to one of a plurality of antennas 198 (four antennas in the illustrated embodiment).

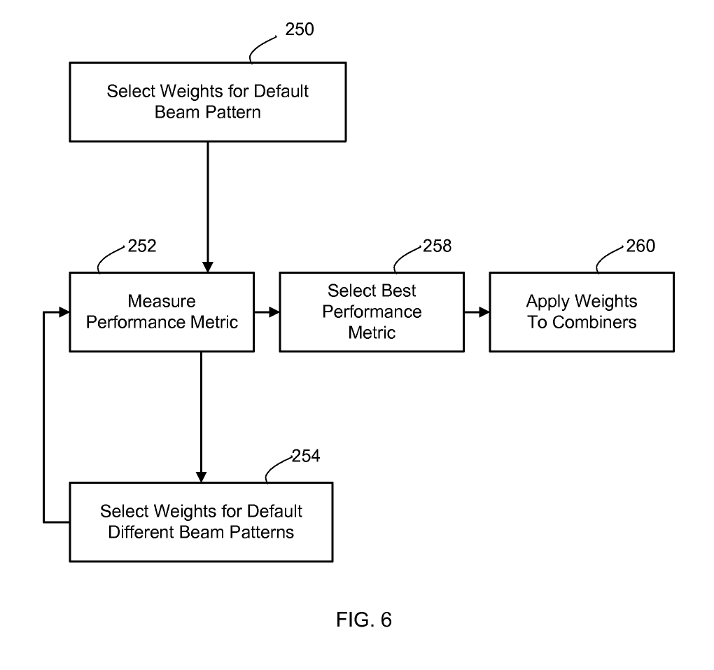

According to one embodiment, a MIMO antenna algorithm executes the following steps, as depicted in FIG. 6. At an initialization step 250 a beamforming weight set is applied to the combiners 200, 202, 204 and 206 (of FIG. 5) to achieve a default beam pattern (e.g., each weight comprises all 1's).

A performance metric is determined for the default beam pattern at a step 252.

At a step 254 different weight values are selected to create a number of predefined beam patterns during a beam pattern trial interval. In one embodiment the weights are selected according to a round robin approach. During this step, a different beamforming weights are applied to each of the combiners 200, 202, 204 and 206. In lieu of the predefined round robin approach, weights are randomly selected or predetermined according to an algorithm. After each weight set is selected and applied to the combiners 200, 202, 204 and 206, a performance metric is determined at the step 252. The performance metric can be measured at each of the mobile units (for the downlink signals) and transmitted to the base station, or the performance metric can be measured at the base station (for the uplink signals) for each of the mobile units. Processing loops through the steps 252 and 254; applying different weights and measuring one or more performance metrics for each weight set.

For example, a fast Fourier transform (FFT) matrix can be used to determine a candidate set of beamforming weights, with each matrix column setting forth a candidate beamforming vector and the corresponding beamforming weights comprising row elements of the column.

At a step 258 the best performance metric is selected and the beamforming weight calculation unit 194 of FIG. 5 generates the corresponding beamforming weights w1, w2, w3 and w4 associated with the selected beam pattern. The selected weights are applied to the combiners 200, 202, 204 and 206 at a step 260.

In another embodiment, the weights are determined using the best measured signal metric(s). In yet another embodiment, when the location of the interferer is known the weights are selected to place a beam pattern null at a location or direction from which the interfering signals reaches BTS. In still another embodiment, one or more of the weights are iterated during the trial interval based on the measured performance metric(s). The weight iterations continue until a desired performance metric is achieved.

Another embodiment of this technique uses a minimum mean-squared-error (MMSE) based beam forming vector calculation. In this approach, the signal to interference plus noise ratio (SINR) is minimized by the MMSE optimization technique. One advantage of this approach is it is unnecessary to determine the direction of arrival of the interfering signal as only the overall SINR is maximized. The potential drawback is that this method requires precise channel state information (e. g., a coefficient representative of the fading channel characteristics).

In the various embodiments described above, about ten different beam patterns are formed during the trial interval. Each beam pattern is active for about 5-10 ms to permit the performance metrics for each beam pattern to be determined.

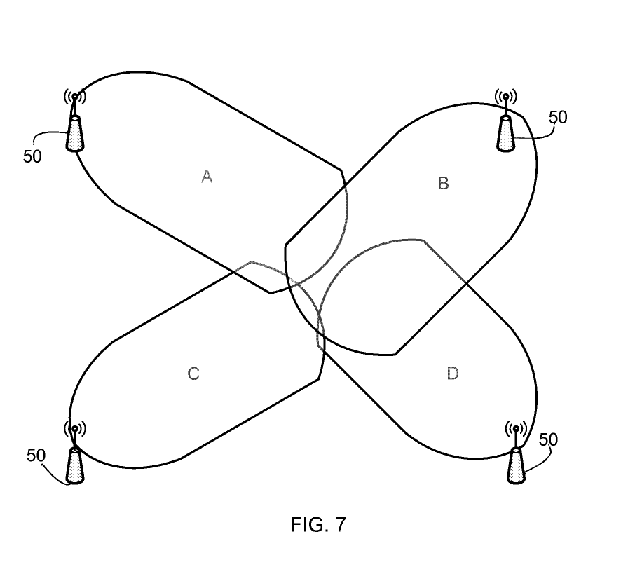

When multiple proximate picocells/femtocells are deployed, such as coverage areas A, B, C, and D as illustrated in FIG. 7, one is expected to observe RF performance degradations at the mobile units operating in one of the coverage areas and/or at the base transceiver stations in the coverage areas. This performance degradation is due to, for example, interference from proximate uplink and downlink signals, signal loss or coverage issues. One embodiment of the present invention provides self organizing networking (SON) functions to optimize the network performance and satisfy a network operator's performance requirements. This SON function is not only applicable to the SPA described above, but also to any antenna technology that provides directional beam features, such as a MIMO antenna.

The SON algorithm of the present invention defines two operational modes. In a distributed control mode SON functions are implemented at the individual femtocell/picocell level without the necessity of coordination with multiple other picocell/femtocell base stations. According to a centralized control mode the SON functions are based on the network information of nearby picocells/femtocells, such as location, RF configuration parameters and antenna beam directions.

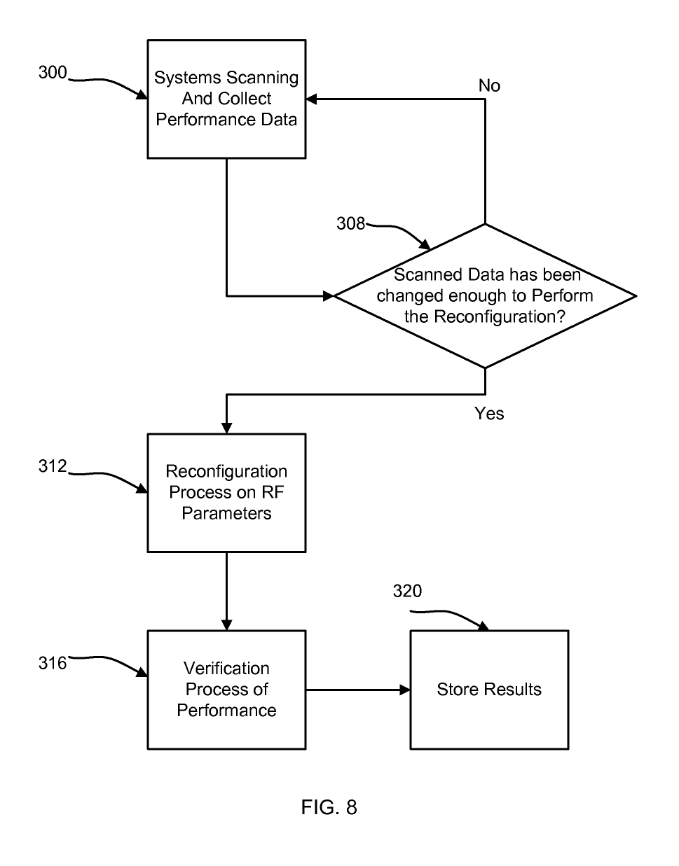

A flowchart depicting the distributed control mode is illustrated in FIG. 8. At a step 300, every picocell/femtocell base station executes an antenna scanning process and for each beam pattern measures performance data from mobile stations and neighboring picocells/femtocells within a given region. In a preferred embodiment the base station collects the performance data based on uplink signals received from the mobile units. In another embodiment the mobile units collect the performance data based on the downlink signals and transmit the collected information to the base station. In either embodiment, performance data collection is performed in several proximate coverage areas, but the antenna beam pattern in each coverage area is determined by the BTS within that coverage area. The antenna beam pattern is controlled by directional beam devices, such as an SPA or a beamforming array as described above.

At a step 308, each picocell/femtocell base station independently decides whether to perform an antenna reconfiguration based upon the measured data for its coverage area, e.g., query whether the performance data collected during the scanning process has changed sufficiently (from a prior scan) to warrant a system reconfiguration. The measured parameters may be evaluated against parameters defined in a key performance index (KPI) based on the network operator's key service requirements.

If the result of the decision step 308 is negative for any coverage area, processing returns to the step 300 to continue scanning the antenna beam in that coverage area and collecting performance data in that coverage area.

For any coverage area in which the decision step 308 returns an affirmative answer, processing continues to a step 312 where the antenna in those affirmative-answer coverage areas of the self-organizing network is reconfigured. Reconfiguration involves one or more of changing the RF output power, adjusting the RF beam-forming (such as a change in the beam-forming direction), changing the direction of the beam, adjusting the antenna tilt, readjusting the frequency, and updating a neighbor cell site list (which will be considered in the next beam direction calculation) and other adjustments known by those skilled in the art. The measurement data determines the specific operational parameter that is modified and the extent of that modification. This analysis is performed by a processing unit or reference is made to a look-up table using the measurement data as an index into the table.

After reconfiguration is completed, a verification process is conducted (step 316) in any reconfigured coverage areas to confirm that the reconfiguration was performed correctly. Typically the verification is accomplished by each reconfigured BTS scanning and collecting additional performance data and comparing it with expected performance data. Once the verification process had been completed, the measured performance data is stored for the next scanning process at a step 320 and the SPA (or other antenna) then operates normally until the next reconfiguration evaluation cycle begins.

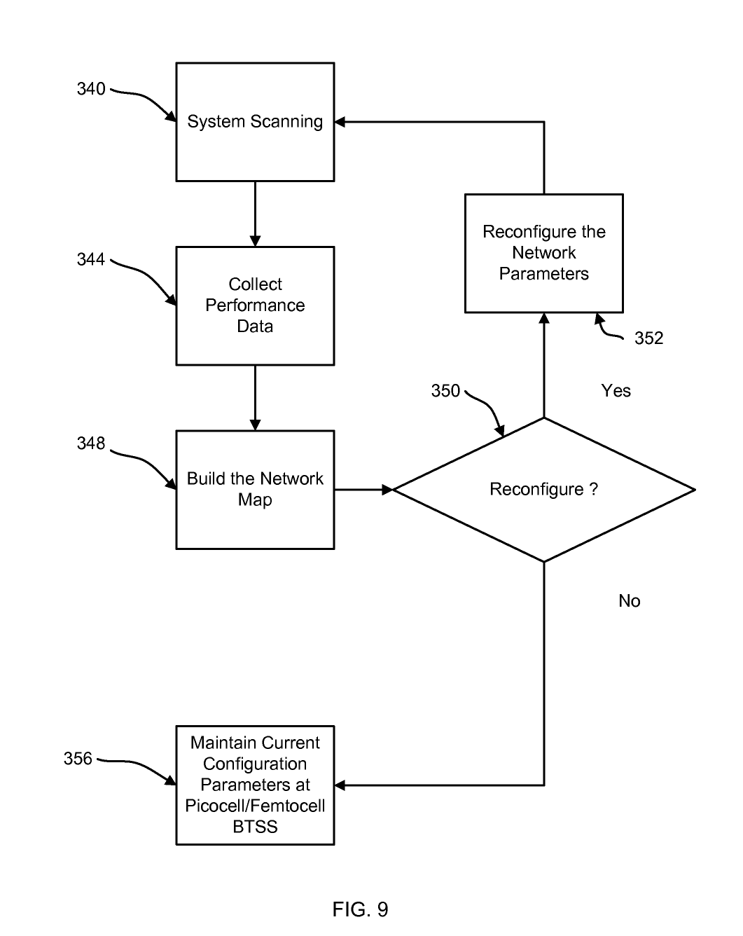

The centralized control mode is illustrated in FIG. 9. A central control management server (e.g., a network management server (NMS) or an element management server (EMS)) with access to cell site topology information and in communications with all BTSs in a region, manages the picocell/femtocell base stations. At a step 340 the central server initiates the scanning process for the picocell/femtocell base stations. At a step 344, each picocell/femtocell BTS collects the performance measurements while each changes beam directions using a SPA, for example. Each picocell/femtocell base station also sends the performance measurement data to the central server. At a step 348 the central server constructs a performance data map that includes all coverage areas in the region (where additional coverage areas, according to a conventional SON, can be added dynamically) based on the collected data and the network topology. At a decision step 350 the central server determines whether it should conduct a network reconfiguration based on the collected performance measurement data, e.g., what is the likelihood that signals in one coverage area will interfere with signals in a different coverage area of the region.

When the central server determines to reconfigure, at a step 352 it commands every picocell/femtocell base transceiver station to conduct the reconfiguration (e.g., to a different beam pattern) using new configuration parameters as defined by the central server and based upon the network operator's key performance indicators. In one embodiment, once all picocell/femtocell base stations complete the reconfiguration, each performs a verification process to ensure the reconfiguration was properly performed.

The process then returns to the step 340, the central server again collects the performance measurement data at the step 344, builds the network map at the step 348 and decides if the new performance measurement data satisfies the desired criteria at the step 350. The process repeats until desired performance parameters are satisfied and the response from the decision step 350 is negative. The last or most recent antenna configuration information is maintained at the picocell/femtocell base transceiver stations at a step 356.

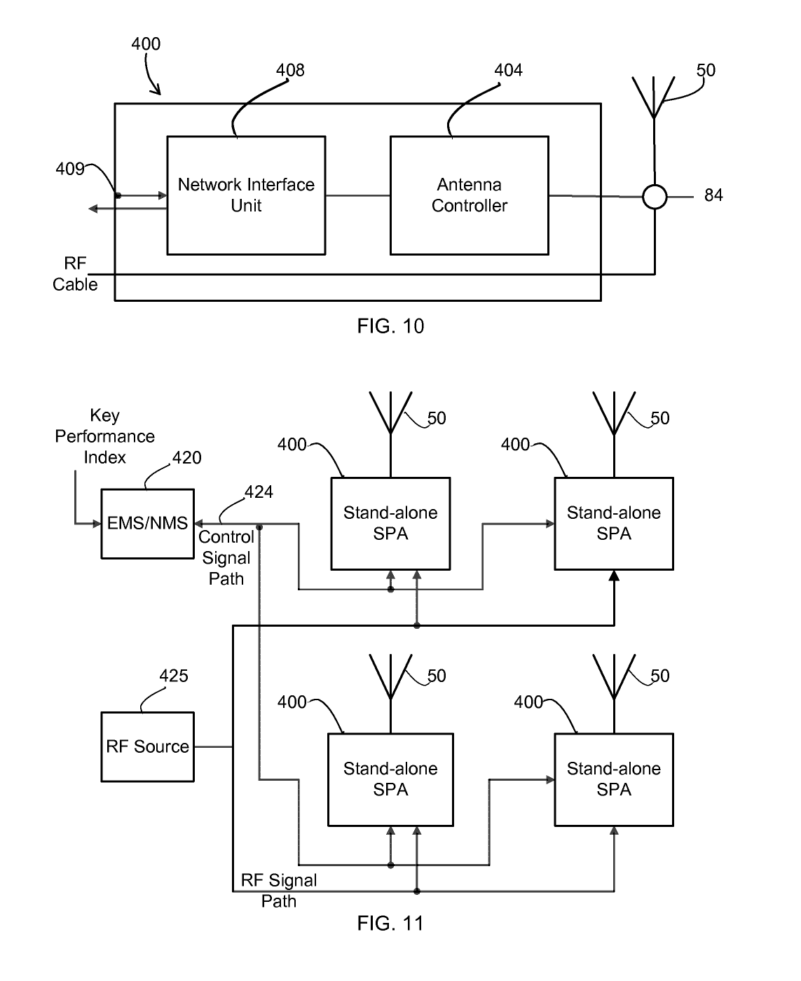

FIG. 10 illustrates a block diagram of a stand-alone SPA antenna system 400 that can be applied to an existing in-building distributed antenna systems (DAS) or a macro cell coverage area. The system 400 comprises an antenna controller 404, a network interface unit 408 and the beam control switches 84. An antenna control signal is determined at an EMS/NMS (element management system/network management system) and supplied to a control input terminal 409 over either a wireline or a wireless network. The control signal, which is supplied to the antenna controller 404 via a network interface unit 408, represents an antenna beam pattern. The controller 404 converts the control signal to SPA-specific control voltages for creating the commanded beam pattern.

The stand-alone antenna system 400 may be located at a remote site and receive power from the remote site to simplify installation. In one application the network interface unit 408 supports a power of Ethernet (PoE) standard, permitting both power and antenna control signals to be supplied over the network wireline.

FIG. 11 presents an example of a deployment of the antenna system 400 of FIG. 10. Each stand-alone SPA antenna system 400 is controlled from a remote EMS/NMS 420 over a control signal network illustrated in FIG. 11 by a bidirectional communications path 424. Each stand-alone SPA antenna system 400 is also responsive to an RF signal supplied from an RF source 425. After installation, each antenna system 400 receives control and beamforming signals from the EMS/NMS 420. Each antenna system 400 also periodically sends performance measurement data back to the EMS/NMS 420, over the path 424, for performing a centralized RF optimization function. Key performance index parameters (such as an SINR for each SPA 400) are input to the EMS/NMS 420.

When the key performance index parameters are available, the system operates in an “intelligent” mode in which the EMS/NMS 420 computes control signals for each SPA 400 using an optimization technique. In an embodiment in which the key performance parameters are not available, the system operates in a so-called “dumb” mode. The EMS/NMS 420 cannot compute control signals for each SPA 400 and instead the control signals are generated manually.

It is possible, according to one embodiment of the present invention, to directly decrease interference by determining a direction to an interfering signal and configuring the antenna elements to place a null in the beam pattern in that direction. However, certain of the embodiments presented above indirectly determine the direction to an interfering signal and use practical approaches to limiting that interference.

The teachings of the present invention are applicable to any wireless standard or protocol as applied to femtocell or picocell networks, such as IEEE 802.11x, WLAN, 3GPP, WCDMA, WiMAX, (IEEE 802.16e, IEEE 802.16m), LTE, and 3GPP, LTE, and wireless LAN (IEEE 802.11n). Certain of these protocols employ multiple antennas to increase data throughput (i.e., each antenna sending/receiving one data stream) and increase spatial diversity. The teachings of the present invention, both the SPA embodiment and the MIMO embodiment, can be applied to any of these standards and antenna configurations.

The references herein to femtocell networks, femtocell coverage areas, etc. are intended to include like references to picocell networks, picocell coverage areas, etc.

As described, the base transceiver station and associated elements of the present invention are a unique and non-obvious device for limiting inter-cell interference in a femtocell/picocell environment. Although the invention has been shown and described with respect to certain preferred embodiments, it is obvious that equivalent alterations and modifications will occur to others skilled in the art upon reading and understanding this specification and the annexed drawings. In particular regard to the various functions and attributes performed by the above described elements, these are intended to correspond to any element that performs the specified function of the described element (i.e., that is functionally equivalent), even though not structurally equivalent to the disclosed structure. In addition, while a particular feature of the invention may have been disclosed with respect to only one of several embodiments, such feature may be combined with one or more other features of the other embodiments as may be desired and advantageous for any given or particular application.

What is claimed is:

1. A first femtocell base transceiver station operative in a first femtocell coverage area and a second femtocell base transceiver station operative in a second femtocell coverage area, the first femtocell coverage area proximate the second femtocell coverage area, the first femtocell base transceiver station comprising:
a base station transmitter for transmitting first downlink signals to mobile units operating within the first femtocell coverage area;
a base station receiver for receiving first uplink signals from the mobile units operating within the first femtocell coverage area;
the second femtocell base transceiver station for transmitting second downlink signals to mobile units operating within the second femtocell coverage area, a power of the second downlink signals greater than a power of the first uplink signals making the first uplink signals susceptible to interference from the second downlink signals;
an antenna for transmitting the first downlink signals as supplied from the base station transmitter and for receiving the first uplink signals and supplying the first uplink signals to the base station receiver, the antenna controllable to produce a plurality of beam patterns;
an antenna controller for controlling the antenna to each one of the plurality of beam patterns;
a signal metric measuring device within mobile units operating within the first femtocell coverage area for measuring a signal metric of the first downlink signals as received at each mobile unit for each one of the plurality of beam patterns, the signal metric of the first downlink signals measured during transmission of the second downlink signal;
a mobile transmitter within mobile units operating within the first femtocell coverage area for transmitting the measured signal metrics from each receiving mobile unit operating within the first femtocell region to the base station receiver;
a processing unit responsive to the base station receiver for receiving the measured signal metrics and for selecting a beam pattern from among the plurality of beam patterns responsive to the measured signal metrics, a beam pattern selected to reduce a received power level of any second downlink signals that reach the antenna; and
the antenna controller for controlling the antenna to the selected beam pattern when operating in a receive mode to receive the first uplink signals, the selected beam pattern to reduce interference to the first uplink signals caused by the second downlink signals.

2. The first femtocell base transceiver station of claim 1 wherein the selected beam pattern is applied to uplink signals from all mobile units transmitting an uplink signal to the base station receiver.

3. The first femtocell base transceiver station of claim 1 wherein the processing unit selects a unique beam pattern for each mobile unit transmitting an uplink signal to the base station receiver and the antenna controller controls the antenna to the unique beam pattern when the associated mobile unit transmits an uplink signal to the base station receiver.

4. The first femtocell base transceiver station of claim 1 wherein the first downlink signals and the first uplink signals are both on a first frequency and time division multiplexed to avoid interference between the first uplink signals and the first downlink signals.

5. The first femtocell base transceiver station of claim 1 wherein the processing unit selects one of the plurality of beam patterns to optimize the signal metrics for all mobile units.

6. The first femtocell base transceiver station of claim 1 operative to reduce interference to the first uplink signals by signals communicated within a macrocell coverage area proximate or overlying the first femtocell coverage area.

7. The first femtocell base transceiver station of claim 1 wherein the antenna comprises a switched parasitic array, further comprising an active antenna element and a plurality of switched parasitic elements disposed around the active element.

8. The first femtocell base transceiver station of claim 1 wherein the signal metric measuring device measures the signal metric of the first downlink signals received at each of the mobile units for each of the plurality of beam patterns during a trial interval.

9. The first femtocell base transceiver station of claim 1 wherein the signal metric measuring device measures the signal metric of the first downlink signals received at each of the mobile units for each of the plurality of beam patterns during an initial trial interval and thereafter during additional trial intervals.

10. The first femtocell base transceiver station of claim 1 wherein the antenna comprises a MIMO beam forming antenna comprising a plurality of antennas, each responsive to a different signal weight for determining the beam pattern of the antenna.

11. The first femtocell base transceiver station of claim 10 wherein the signal weights are determined to locate a null of the antenna pattern at a location from which the second downlink signals reach the first femtocell base transceiver station.

12. The first femtocell base transceiver station of claim 1 wherein the transmitter and the receiver operate according to any wireless protocol.

13. The first femtocell base transceiver station of claim 11 wherein the wireless protocols comprise IEEE 802.11x, WLAN, 3GPP, WCDMA, 3GPP LTE, LTE and WiMAX.

14. The first femtocell base transceiver station of claim 1 further comprising a signal metric measuring device within the base transceiver station for measuring a signal metric of the first uplink signals, wherein the processing unit selects one of the plurality of beam patterns responsive to the signal metric of the first uplink signal and the signal metric determined by one or more of the signal metric measuring devices within the mobile units.

15. The first femtocell base transceiver station of claim 1 wherein the second downlink signal comprises a pilot signal transmitted to mobile units operating in the second femtocell coverage area from the second femtocell base transceiver station.

16. The first femtocell base transceiver station of claim 1 wherein the first downlink signal comprises a pilot signal transmitted from the first femtocell base transceiver station to mobile units operating in the first femtocell coverage area.

17. The first femtocell base transceiver station of claim 1 wherein the first uplink signal sent from a first mobile unit from among the mobile units operating within the first femtocell coverage area and the first down link signal sent to the first mobile unit utilize the same frequency according to a time division duplex protocol.

18. A first femtocell base transceiver station operative in a first femtocell coverage area and a second femtocell base transceiver station operative in a second femtocell coverage area, the first femtocell coverage area proximate the second femtocell coverage area, the first femtocell base transceiver station comprising:
a base station transmitter for transmitting first downlink signals to mobile units operating within the first femtocell coverage area;
a base station receiver for receiving first uplink signals from the mobile units operating within the first femtocell coverage area;
the second femtocell base transceiver station for transmitting second downlink signals to mobile units operating within the second femtocell coverage area, a power of the second downlink signals greater than a power of the first uplink signals making the first uplink signals susceptible to interference from the second downlink signals;
a primary antenna responsive to the base station transmitter for transmitting the first downlink signals and receiving the first uplink signals, the primary antenna controllable to produce a plurality of beam patterns;
an antenna controller for controlling the primary antenna to one of the plurality of beam patterns;
secondary antennas;
a processing unit for determining an angle of arrival of a signal interfering with the first uplink signals within the first femtocell coverage area, the angle of arrival determined from signals received at the primary antenna and the second antennas; and
the antenna controller for controlling the primary antenna to locate a null of a primary antenna beam pattern at the angle of arrival.

19. A method for controlling an antenna of a first femtocell base transceiver station operative in a first femtocell coverage area, the first femtocell coverage area proximate a second femtocell coverage area comprising a second femtocell base transceiver station, the method comprising:
(a) transmitting a pilot signal from the antenna of the first femtocell base transceiver station to mobile units operating within the first femtocell coverage area;
(b) at one or more of the mobile units, measuring a signal metric of the pilot signal and returning a signal indicative thereof to the first femtocell base transceiver station;
(c) configuring the antenna to a different beam pattern and repeating steps (a) and (b) until the antenna has been configured to all available beam patterns; and
(d) determining a beam pattern from among the different beam patterns responsive to measured signal metrics, the beam pattern selected to minimize interference to signals sent from the mobile units operating in the first femtocell coverage area to the first femtocell base transceiver station, the interference caused by signals sent from the second femtocell base transceiver station to mobile units operating within the second femtocell coverage area.

20. A method for operating a self-organizing network comprising a plurality of femtocell or picocell coverage areas and mobile units operating in each coverage area, each coverage area comprising a base transceiver station and an antenna operative therewith, the method comprising:
(a) at each base transceiver station, scanning an antenna beam;
(b) measuring performance data as the scanning step is executed;
(c) at each base transceiver station determining whether measured performance data indicates a network reconfiguration;
(d) if a result from the step of determining is negative at a first base transceiver station, returning to the step of scanning the antenna beam of the first base transceiver station;
(e) if the result from the step of determining is affirmative at the first base station, reconfiguring the network by changing a network operating parameter responsive to the measured performance data, wherein the network operating parameters comprise an RF output power of the first base transceiver station, an antenna beam pattern of an antenna associated with the first base transceiver station, an antenna tilt angle of the antenna associated with the first base transceiver station, an operating frequency of the first base transceiver station and a proximate cell site list of the first base transceiver station; and
(f) storing the measured performance data.

21. The method of claim 20 wherein step (c) comprises comparing the performance data with previously collected performance data and if the difference exceeds a threshold reconfiguring the network according to step (e).

22. The method of claim 20 wherein the performance data comprises performance data for a single femtocell or picocell coverage area or for a plurality of femtocell or picocell coverage areas within the self-organizing network.

23. The method of claim 20 wherein step (b) comprises:
(b1) measuring the performance data at the base transceiver station or
(b2) measuring the performance data at one or more mobile units and transmitting the performance data to the base transceiver station.

24. The method of claim 20 wherein step (c) further comprises determining whether the performance data satisfies a network operator's performance indicators.

25. The method of claim 20 further comprising a step (f) verifying whether step (e) has been properly executed.

26. The method of claim 20 wherein step (e) further comprises changing one or more network operating parameters based on a key performance index.

27. The method of claim 20 wherein step (e) further comprises
(e1) changing one or more network operating parameters;
(e2) scanning the antenna beam at the first base transceiver station;
(e3) measuring performance data as the scanning step is executed; and
(e4) repeating steps (e1) through (e3).

28. A method for determining whether to reconfigure a self-organizing network comprising a plurality of femtocell or picocell coverage areas and mobile units operating in each coverage area, each coverage area comprising a base transceiver station and an antenna operative therewith, the method comprising:
(a) at each base transceiver station, scanning an antenna beam;
(b) measuring performance data as the scanning step is executed;
(c) forwarding the performance data to a network management site;
(d) building a performance data map using measured performance data;
(e) determining whether the map indicates a need for a network reconfiguration;
(f) if a result from step (e) is negative, returning to the step of scanning the antenna beam;
(g) if the result from the step (e) is affirmative, reconfiguring the network by changing one or more network operating parameters, the network operating parameters comprising an RF output power of one or more base transceiver stations in the network, an antenna beam pattern of one or more antennas in the network, an antenna tilt angle of one or more antennas in the network, an operating frequency of one or more base transceiver stations, a proximate cell site list for one or more of the base transceiver stations, wherein the network operating parameter changed and the extent to which the network parameter is changed is responsive to the measured performance data; and
(h) storing the measured performance data.

29. The method of claim 28 wherein step (e) further comprises determining differences between a current network map and a previous network map, if differences exceed a threshold, reconfiguring the network according to step (g).

30. The method of claim 28 wherein step (e) further comprises determining whether the performance data as set forth in the performance data map satisfies a network operator's key performance indicators.

31. The method of claim 28 wherein the performance data comprises performance data for a single femtocell or picocell coverage area or for a plurality of femtocell or picocell coverage areas within the self-organizing network.

32. The method of claim 28 wherein step (b) comprises:
(b1) measuring the performance data at the base transceiver station or
(b2) measuring the performance data at one or more mobile units and transmitting the performance data to the base transceiver station.
